(19) United States
(12) Patent Application Publication
(10) Pub. No.: US 2018/0089740 A1
(43) Pub. Date: Mar. 29, 2018

(54) SYSTEM FOR IDENTIFYING AND SUGGESTING GOODS FOR PURCHASE

(71) Applicant: Stephanie Reese, Highlands, NJ (US)

(72) Inventor: Stephanie Reese, Highlands, NJ (US)

(21) Appl. No.: 15/714,374

(22) Filed: Sep. 25, 2017

Related U.S. Application Data
(60) Provisional application No. 62/399,009, filed on Sep. 23, 2016.

(51) Int. Cl. G06Q 30/06

(52) U.S. Cl. CPC G06Q 30/0631; G06Q 30/0603; G06Q 30/0641; G06Q 30/0623

(57) ABSTRACT

Systems and methods are provided for suggesting goods for purchasing. The method includes: selecting, using a first electronic device, a first user; selecting, using the first electronic device, one or more goods from one or more catalogs of goods; constructing, using a processor, a message, wherein the message includes: at least one of the one or more goods selected by a second user using the first electronic device; a description of each of the goods included in the message; and an interface with which the first user can select any of the goods included in the message; sending, using a processor, the message to the first user on a second electronic device; receiving, by the processor, any goods selected by the first user; and sending, using the processor, a listing of any goods selected by the first user on the second electronic device.

### CLAIM OF PRIORITY

This application is a United States non-provisional application and claims benefit to U.S. Provisional Patent Application No. 62/399,009, filed Sep. 23, 2016 and referenced herein in its entirety.

### FIELD OF THE EMBODIMENTS

This invention and its embodiments relate to feedback loops and, more particularly, to feedback loops for communication between a gift buyer and a gift recipient.

### BACKGROUND OF THE EMBODIMENTS

For many gift givers, one of the main goals of the gifting process is the element of surprise; surprise as to what the gift is and/or to the identity of the gift giver. Currently, the gifting process is inefficient. There exists no method to enable a gift giver to be guaranteed that the gift they acquire would be liked by the gift recipient without having to first directly ask the gift recipient, or resorting to referring to the gift recipient's online wish list. Either way, using those methods, the gift recipient is going to know what the gift is and/or who the gift giver is. This detracts from the “magic” of gift giving.

As a result of the negative consequences of directly asking the gift recipient or choosing an item on the gift recipient's wish list, the following resulting scenarios are likely to occur:
The gift giver decides to search for a gift without any input from the gift recipient, leading to the gift giver wasting time searching for a gift that the gift recipient may not even like.
Awkward and sometimes embarrassing encounters result from a gift recipient receiving a gift that is undesirable.
The gift may be underwhelming, boring, or from a gift registry, leading to the gift recipient to be, at best, unsurprised, and, at worst, let down by the gift.
If the gift is undesirable, the gift giver or the gift recipient is stuck with the hassle and cost of returning the undesired gift, or is stuck with the annoyance of unwanted clutter due to having possession of the unwanted gift.
Retailers may lose money due to the various costs that they incur due to the returning of undesired gifts.

It is thus apparent a better way is needed gift givers to purchase gifts that gift recipients truly like without having to spoil the fun and magic of the gifting experience for gift giver and/or the gift recipient.

Tangentially, e-retailers and brick-and-mortar retailers need a way to avoid merchandise being returned due to the merchandise being unwanted gifts or gifts of the wrong fit or size. Presently, ecommerce return rates average approximately 17-25%.

Examples of related art are described below:

U.S. Patent Application. No. 2014/0372251 pertain to a method for providing a gift to a recipient. The method includes providing a website on which is displayed a set of gifts and a set of selectable gift values; receiving input from a gift giver which includes (a) a designated recipient for a gift, and (b) gift criteria which includes a gift value selected by the gift giver from said set of selectable gift values; creating a URL associated with the designated recipient upon which is displayed a subset of said set of gifts that meet the gift criteria input by the gift giver; receiving, from the designated recipient, a selection of a gift from said subset of gifts; and sending the selected gift to the recipient.

U.S. Patent Application No. 2009/0164334 pertains to a method and online system for recommending gifts to a user, for a gift recipient, includes determining social relational aspects between the giver and gift recipient, determining personality traits of the giver or the recipient and calculating and then displaying to the user one or more recommended gifts for purchase. Personality, occupation and style traits are numerically rated in conjunction with product attributes of a population of potential gifts for accurate calculation of optimized gift recommendations. Gifts are rated by an online community associated with the system. The system may also learn by a feedback loop for successful and unsuccessful predictions of gift desirability, thus resulting in greater gift recommendation accuracy over time.

U.S. Pat. No. 8,978,978 pertains to a method for facilitating online gift shopping. The method includes: receiving an order for a gift for a recipient from an online shopper via a computer network; providing a gift notice for the recipient to inform the recipient that the gift has been ordered for the recipient; receiving a reply to the gift notice from the recipient via the computer network, wherein the reply includes gift feedback information; and updating a recipient profile responsive to the reply and based on the gift feedback information from the recipient, wherein the recipient profile is associated with the recipient. Computer program products and systems for facilitating online gift shopping are also provided.

U.S. Pat. No. 8,412,585 pertains to a system and methods relating to the online purchase of a gift or other item. A gift recipient may purchase one or more gifts or items and receive such one or more gifts or items immediately. Thereafter, others who would seek to purchase a gift or item for the gift recipient from an online retailer or web service provider may choose to contribute to the cost of the already received gift or item and the gift recipient is reimbursed his cost for purchasing of such immediately received gift or item as the purchasers make such contributions towards the received gift or item.

International Patent Application No. WO2001/002931 pertains to methods, systems, and articles of manufacture for the enablement of an online gift recipient to accept or exchange an online gift prior to shipping the gift to the recipient. A gift giver accesses a gift server over a network (such as the Internet) using conventional browser software on a user node of the network. While online with the gift server node (e.g. the gift server's website), the gift giver selects an online gift for the recipient from a variety of gifts supplied from one or more gift vendors. Information on the gift selection is sent to a gift queue on the gift server node while the recipient is notified of the gift, typically via an electronic mail message. In response to the notification, the recipient connects online to the gift server node, reads the gift selection information from the gift queue and determines whether to accept or exchange the gift. If the gift is to be exchanged, an electronic gift certificate is generated and another gift may be selected or different kinds of actual gift certificates may be selected as a replacement gift before an order for the initial gift is placed or the initial gift is shipped to the recipient.

International Patent Application No. WO2001/016786 pertains to a gift exchange manager for managing a gift exchange conducted on a network. The gift exchange manager includes a gift giver's computer, a recipient's computer, and a gift exchange computer is provided. The gift exchange manager comprises a database including data for a plurality of gifts sorted into mutually exclusive price categories, and a computer program for running on the gift exchange computer. The computer program includes subroutines for displaying the price categories, for accepting input from the gift giver selecting one of the price categories and identifying an address for the recipient, for sending a notification to the recipient that the recipient may select a gift, for displaying gifts in the price category without displaying the price category, for accepting input from the recipient selecting a gift from the price category, and for notifying a supplier to ship the selected gift.

Various devices are known in the art. However, their structure and means of operation are substantially different from the present invention. Such systems, devices, and methods fail to teach or suggest at least a method of constructing a message which includes one or more pre-selected goods, a description of each of those goods, and an interface with which a user can select any of the goods included in the message, sending that message to a user on an electronic device, receiving which of the goods the user selected after receiving the message, and sending a listing of which goods the user liked to another electronic device.

At least one embodiment of this invention is presented in the drawings below, and will be described in more detail herein.

### SUMMARY OF THE EMBODIMENTS

According to an embodiment of the present invention, a method is provided for suggesting goods for purchasing. The method includes: selecting, using a first electronic device, a first user; selecting, using the first electronic device, one or more goods from one or more catalogs of goods; constructing, using a processor, a message, wherein the message includes: at least one of the one or more goods selected by a second user using the first electronic device; a description of each of the goods included in the message; and an interface with which the first user can select any of the goods included in the message; sending, using a processor, the message to the first user on a second electronic device; receiving, by the processor, any goods selected by the first user; and sending, using the processor, a listing of any goods selected by the first user on the second electronic device.

According to another embodiment of the present invention, a method is provided for suggesting goods for purchasing. The method includes: selecting, using a first electronic device, two or more first users; selecting, using one or more first electronic devices, one or more goods from one or more catalogs of goods; constructing, using a processor, a message, wherein the message includes: at least one of the one or more goods selected by at least one second user using the one or more first electronic devices; a description of each of the goods included in the message; and an interface with which each of the at least two first users can select any of the goods included in the message; sending, using a processor, the message to the two or more first users on one or more second electronic devices; receiving, by the processor, any goods selected by the two or more first users; and sending, using the processor, a listing of any goods selected by the first user on the one or more second electronic devices.

It is an object of the present invention to provide for a method for suggesting goods for purchasing, wherein the message does not identify the identity of the second user.

It is an object of the present invention to provide for a method for suggesting goods for purchasing, wherein the message further includes a prompt for the first user to select which goods included in the message the first user likes.

It is an object of the present invention to provide for a method for suggesting goods for purchasing, wherein the message further includes one or more goods generated by the processor, wherein the one or more goods generated by the processor share one or more characteristics with one or more of the goods selected from the one or more catalogs of goods.

### BRIEF DESCRIPTION OF THE DRAWINGS

FIGS. 1-2 show a flowchart of a method for suggesting gifts for purchasing, according to an embodiment of the present invention.

FIG. 3 shows a home screen of the gift giving software, according to an embodiment of the present invention.

FIG. 4 shows a cell phone screen showing the gift recipient gift idea selection screen, according to an embodiment of the present invention.

FIG. 5 shows a cell phone screen showing a recommendation screen, according to an embodiment of the present invention.

FIG. 6 shows a cell phone screen showing traits related to gift ideas, according to an embodiment of the present invention.

FIG. 7 shows a cell phone screen showing gift types, according to an embodiment of the present invention.

FIG. 8 shows a cell phone screen showing instructions to select one or more items, according to an embodiment of the present invention.

FIG. 9 shows a cell phone screen showing instructions to enter the gift giver's information, according to an embodiment of the present invention.

### DESCRIPTION OF THE PREFERRED EMBODIMENTS

Systems and methods are provided for suggesting goods for purchasing.

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

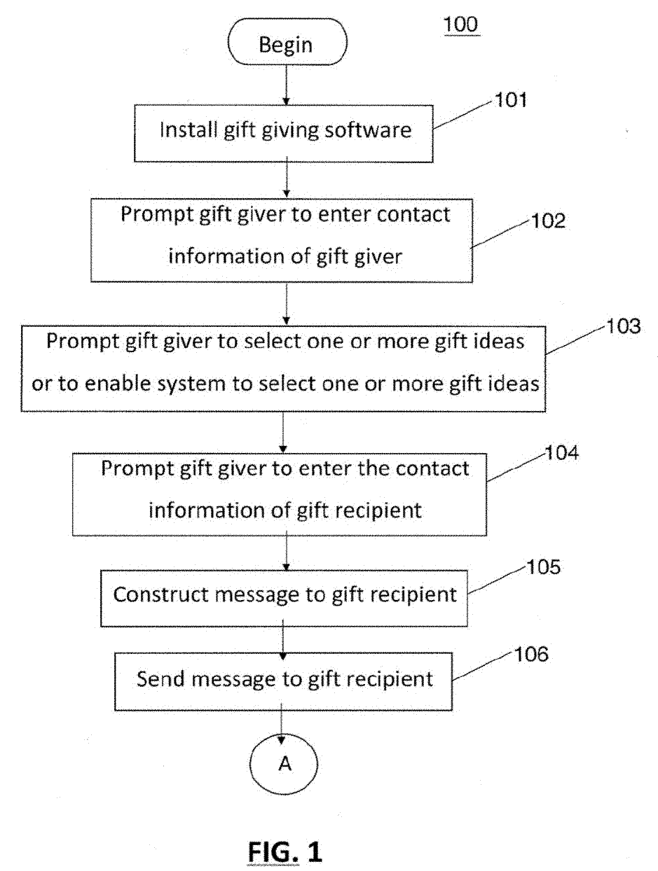

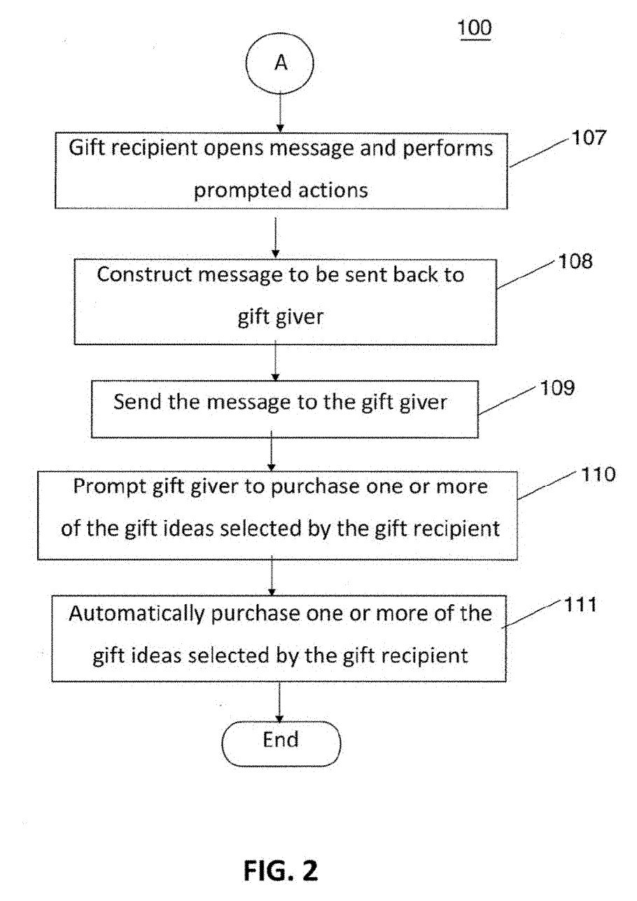

Referring now to FIGS. 1-2, a flowchart of a method 100 for suggesting gifts for purchasing is illustratively depicted, in accordance with an embodiment of the present invention.

At step 101, a gift giver installs the gift giving software of the present invention. The software enables the gift giver to save gift ideas while shopping online. According to an embodiment of the present invention, the gift giving software may include an application, a browser button, etc. According to various embodiments, the gift giving software is accessible on electronic devices such as, but not limited to, cell phones, laptop computers, gaming systems, smart watches, desktop computers, tablet computers, Personal Digital Assistants (PDAs), etc.

At step 102, the gift giving software prompts the gift giver to enter contact information of the gift giver. This enables the gift giving software to return, to the gift giver, a list of gift ideas that the gift recipient has selected that the gift recipient would be interested in receiving as gifts. The contact information may include, but is not limited to, name, phone number, e-mail address, IP address, home address, social media account information, etc. According to some embodiments of the present invention, the contact information includes payment information such as, but not limited to, credit/debit card information, bank account information, etc. According to an embodiment, there are two or more gift givers. According to an embodiment, one or more gift givers may store, share, and delegate gift funds. According to an embodiment, the gift giver may invite other gift givers to contribute to the intended amount to be gifted to the gift recipient.

At step 103, the gift giving software prompts the gift giver to select one or more gift ideas that the gift giver wishes to suggest to the gift recipient. According to an embodiment, the gift giver manually inputs which gifts the gift giver wishes to suggest to the gift recipient. According to an embodiment, the one or more gift ideas are selected from a catalog of goods. According to another embodiment of the present invention, the gift giving software generates all or part of the list of gift ideas without the gift giver having to input any of the gift ideas. These gift ideas may be based on characteristics of one or more of the gift ideas selected by the gift giver. These characteristics may include, but are not limited to, the category of goods, the relative price, the brand of goods, the color, the utility, the size, the style, etc.

According to another embodiment of the present invention, the gift giving software prompts the gift giver to enable the gift giving software, and any accompanying systems, to automatically generate some or all of the gift ideas to be sent to the gift recipient.

It is noted that, according to some embodiments of the present invention, the gift ideas may be selected by an individual, a group of individuals, a brand, a publication, a company, a corporation, or other such entities. According to an embodiment, brands, publications, corporations, retailers, or other similar entities may use the present invention to reward customers and/or employees.

At step 104, the gift giving software prompts the gift giver to input the contact information of the gift recipient. This contact information enables the gift giving software to send a message to the gift recipient that includes, among other data, the gift ideas selected by the gift giver and a prompt to the gift recipient that the gift recipient select any of the gift ideas that the gift recipient would be interested in receiving as gifts. According to an embodiment, there are two or more gift recipients. According to another embodiment, the gift recipient may be chosen by the gift giver, a group of multiple gift givers, or by the gift giving software and accompanying system.

At step 105, the gift giving software constructs a message to be sent to the gift recipient. The message includes at least one or more gift ideas selected by the gift giver, a description of each of the gift ideas, an interface with which the gift recipient can select any of the gift ideas included in the message, and a prompt that the gift recipient select all of the gift ideas included in the message that the gift recipient would be interested in receiving as gifts. According to an embodiment, the message also includes gift ideas selected by one or more computer processors running the gift giving software. These gift ideas may be recommended based on one or more of the gift recipients interests, hobbies, relationships with others, or other criteria.

According to an embodiment, the message includes a link to a webpage that contains all or some of the at least one or more gift ideas selected by the gift giver, the description of each of the gift ideas, the interface with which the gift recipient can select any of the gift ideas included in the message, the gift ideas selected by one or more computer processors running the gift giving software, and the prompt that the gift recipient select all of the gift ideas included in the message that the gift recipient would be interested in receiving as gifts. According to an embodiment, the message does not include the identity of the gift giver. This enables the gift giver to remain anonymous. According to another embodiment, the identity of the gift giver is not anonymous. According to an embodiment, the gift giver is presented with an option to remain anonymous or to be known. According to an embodiment, if the gift giver chooses to be known, the gift purchased by the gift giver remains anonymous until the gift is received by the gift recipient.

According to an embodiment, the one or more gift ideas generated by the one or more computer processors share one or more characteristics with one or more of the gift ideas selected by the gift giver. According to an embodiment, the characteristics include, but are not limited to, category of goods, relative price, brand of goods, color, utility, size, style, etc.

According to an embodiment, the message includes a timeframe in which the gift recipient is to respond to one or more prompts in the message.

At step 106, the gift giving software sends the message the gift recipient. According to an embodiment, the message is sent via e-mail or text message. However, other forms of electronic communication may also be used, while maintaining the spirit of the present invention.

At step 107, the gift recipient opens the message and selects which of the gift ideas the gift recipient would be interested in receiving as gifts. According to an embodiment, the message optionally allows the gift recipient to select gift items from any site, which were not displaying in the original message, to be sent in a message back to the gift giver as gift options.

According to an embodiment, the gift recipient's responses to the prompts are stored in a memory. According to an embodiment, these stored responses may be used to refine future recommended gift ideas.

At step 108, the gift giving software constructs a message including a list of all of the gift ideas that the gift recipient selected.

At step 109, the gift giving software sends the message with the list of all of the gift ideas selected by the gift recipient to the gift giver. According to an embodiment, the message is sent via e-mail or text message. However, other forms of electronic communication may also be used, while maintaining the spirit of the present invention. According to an embodiment, the gift giver determines the method by which the message is returned back to the gift giver.

At step 110, the gift giving software prompts the gift giver to purchase one or more of the gift ideas selected by the gift recipient.

Alternatively, at step 111, the gift giving software automatically purchases one or more gift ideas selected by the gift recipient upon being selected by the gift recipient. According to an embodiment, the gift giving software completes the purchase using the payment information submitted by the gift giver.

It is noted that, in addition to the stated software and hardware, other software and hardware may also be implemented during any of the processes of the present invention. These may include, but are not limited to, virtual reality software and hardware, televisions, projectors, etc.

It is further noted that the present method 100 is provided as an example and that the various steps included within the method 100 may be performed in any order, or may be repeated. It is further noted that the steps presented are not exhaustive and that one or more of the steps may be omitted, while maintaining the spirit of the present invention.

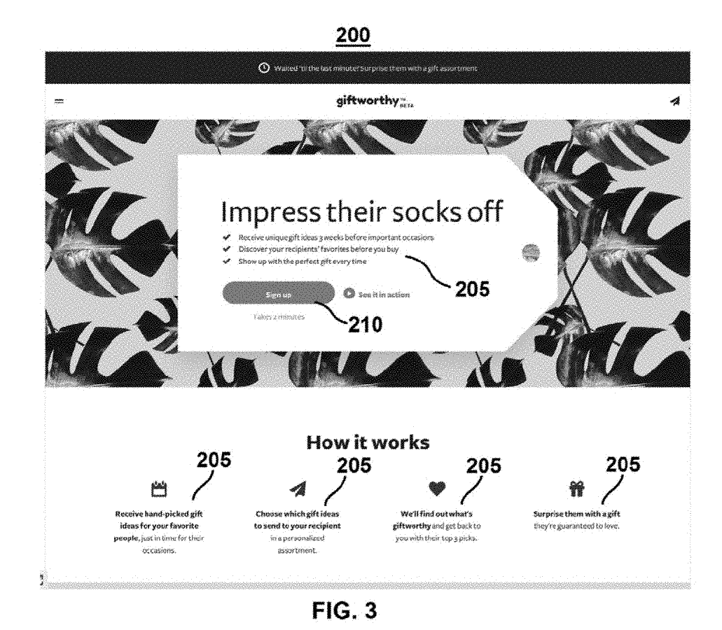

Referring now to FIG. 3, a home screen 200 of the gift giving software is illustratively depicted, in accordance with an embodiment of the present invention.

According to an embodiment, the home screen 200 provides information 205 pertaining to the gift giving software. According to an embodiment, the information 205 includes descriptive phrases such as, e.g., “Receive unique gift ideas 3 weeks before important occasions,” “Discover your recipients' favorites before you buy,” “show up with the perfect gift every time,” “Receive hand-picked gift ideas for your favorite people, just in time for their occasions,” “Choose which gift ideas to send to your recipient in a personalized assortment,” “We'll find out what's giftworthy and get back to you with their top 3 picks,” “Surprise them with a gift they're guaranteed to love,” and/or any other suitable phrases.

According to an embodiment, the home screen 200 also includes a link 210 to sign up for the services provided by the gift giving software.

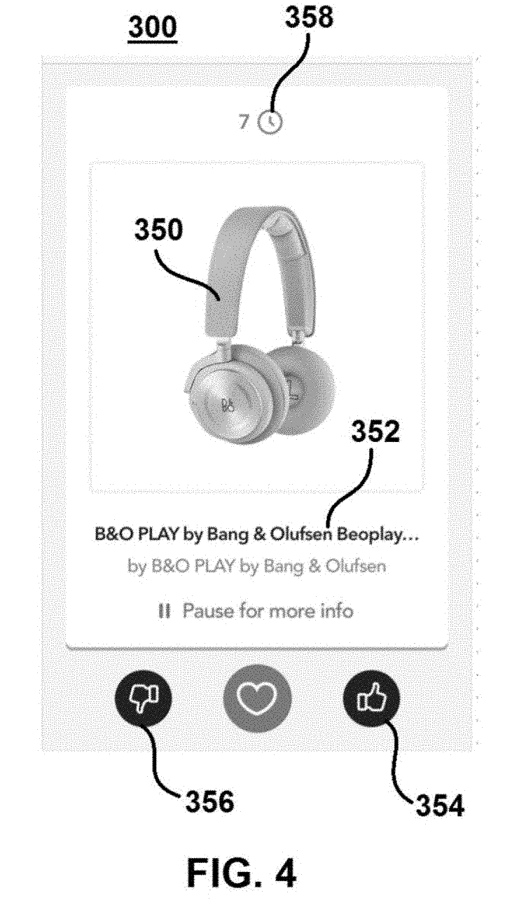

Referring now to FIG. 4, a cell phone screen 300 showing the gift recipient gift idea selection screen is illustratively depicted, in accordance with an embodiment of the present invention.

According to an embodiment, the gift idea selection screen includes an image 350 of a gift idea, the title 352 of the gift idea, options to like 354 and dislike 356 the gift idea, and a timer 358 showing how much time is left to make the selection. According to an embodiment, if there are multiple gift ideas, the selection screen identifies which gift idea is being shown in relation to the other gift ideas. According to an embodiment, the selection screen further shows a description of the gift idea shown.

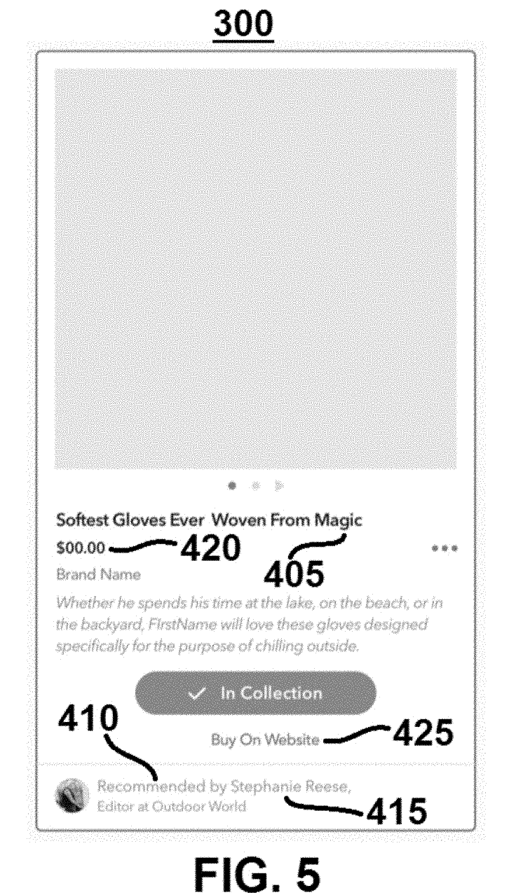

Referring now to FIG. 5, a cell phone screen 300 showing a recommendation screen is illustratively depicted, in accordance with an embodiment of the present invention.

According to an embodiment, the recommendation screen indicates that the item or items 405 are recommended 410. According to an embodiment, the individual or individuals 415 who recommended the item or items 405 are listed. According to an embodiment, a price 420 of the item or items is shown. According to an embodiment, an option to purchase 425 the item or items 405 is shown.

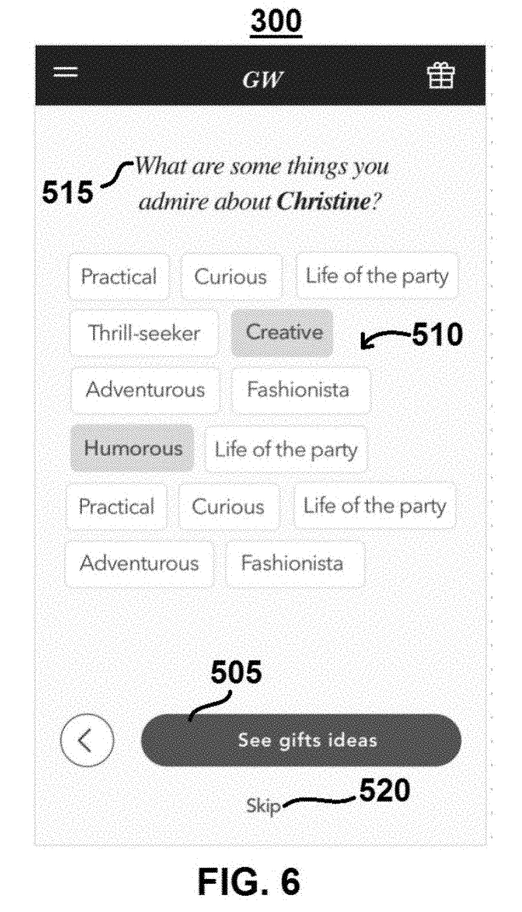

Referring now to FIG. 6, a cell phone screen 300 showing traits related to gift ideas is illustratively depicted, in accordance with an embodiment of the present invention.

According to an embodiment, the gift giving software provides gift ideas based on selected traits 510. According to an embodiment, the user is instructed 515 to select on or more traits 510 about the gift receiver. These traits 510 may include, e.g., “practical,” “curious,” “life of the party,” “thrill-seeker,” “creative,” “adventurous,” “fashionista,” “humorous,” and/or any other relevant traits 510. A user is given the option to see 505 the gift ideas based, in whole or in part, on the selected traits 510. According to an embodiment, the user is given the option to skip 520 this step.

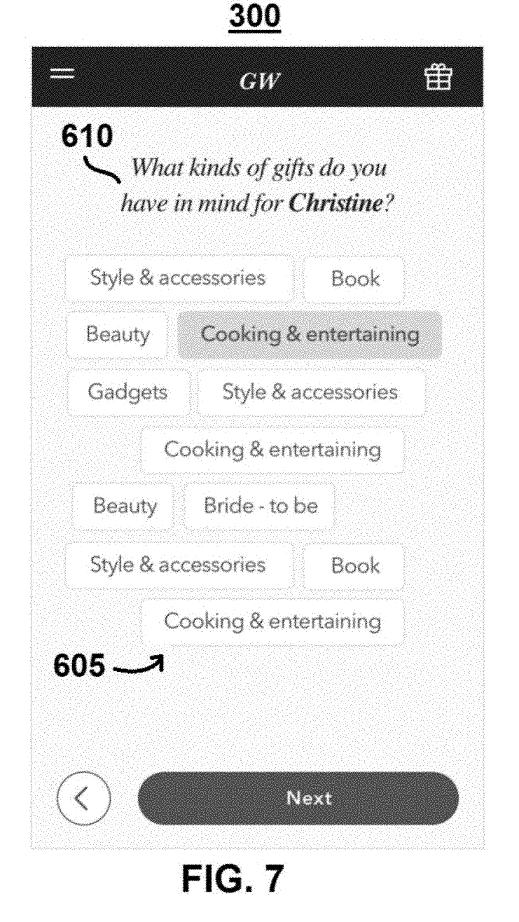

Referring now to FIG. 7, a cell phone screen 300 showing gift types is illustratively depicted, in accordance with an embodiment of the present invention.

According to an embodiment, the gift giving software provides gift types 605 to the user. According to an embodiment, the user is instructed 610 to select on or more gift types 605. These gift types 605 may include, e.g., “style & accessories,” “book,” “beauty,” “cooking & entertainment,” “gadgets,” “bride-to-be,” and/or any other relevant gift types 605.

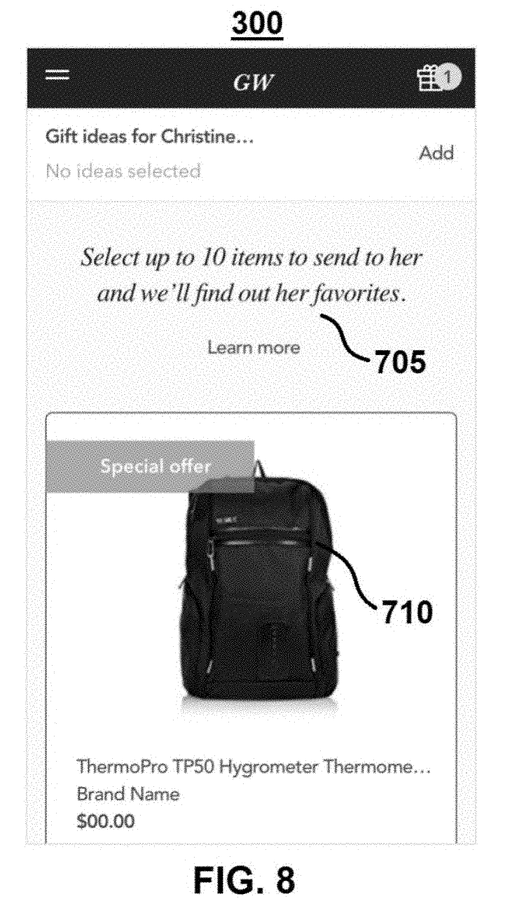

Referring now to FIG. 8, a cell phone screen 300 showing instructions 705 to select one or more items 710 is illustratively depicted, in accordance with an embodiment of the present invention.

According to an embodiment, the user is instructed 705 to select a number of items 710 to determine which of those items 710 are the gift receiver's favorites. According to an embodiment, there is a maximum number (e.g., 10) of items 705 that can be selected.

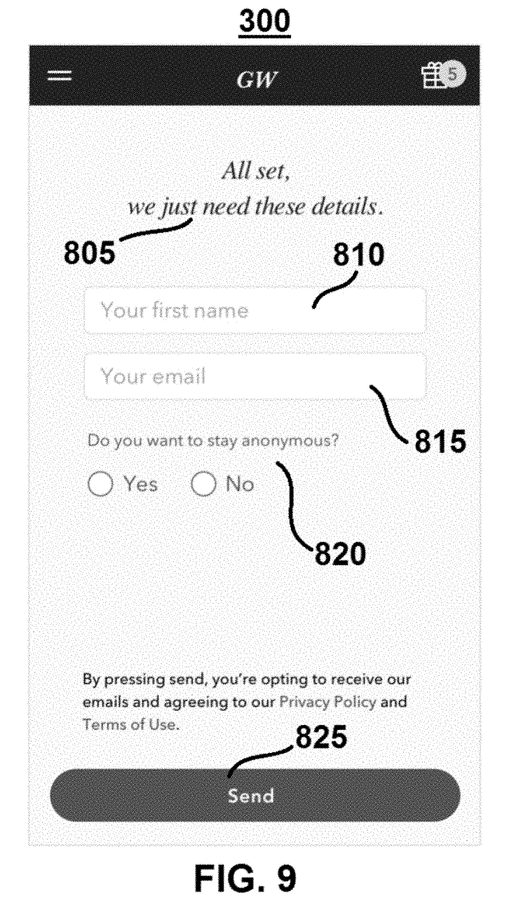

Referring now to FIG. 9, a cell phone screen 300 showing instructions 805 to enter the gift giver's information is illustratively depicted, in accordance with an embodiment of the present invention.

According to an embodiment, the user is instructed 805 to enter the gift giver's name 810 and e-mail address 815 before sending 825 the request. According to an embodiment, the gift giver can choose whether or not to remain anonymous 820.

Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols, for example the antenna(s) may connect to: a Texas Instruments WiLink WL1283 transceiver chip (e.g., providing 802.11n. Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel and/or super-computer architectures may similarly be employed. Alternatively, should deployment requirements dictate greater portability, smaller PDAs may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNLX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95198/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself and/or the like. Most frequently, the operating system communicates with other program components, user interfaces, and/or the like. For example, the operating system may contain, communicate, generate, obtain and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP). SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5). Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

Various other components may be included and called upon for providing for aspects of the teachings herein. For example, additional materials, combinations of materials and/or omission of materials may be used to provide for added embodiments that are within the scope of the teachings herein. In the present application a variety of variables are described, including but not limited to components and conditions. It is to be understood that any combination of any of these variables can define an embodiment of the disclosure. Other combinations of articles, components, conditions, and/or methods can also be specifically selected from among variables listed herein to define other embodiments, as would be apparent to those of ordinary skill in the art.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

The many elements of the present invention make it unique in the field. The novelty is illustrated by the various options for nearly every aspect of the invention that allow it to be used in the proper exercise form by a variety of users, both in terms of body size and fitness level. Additionally, there is a wide range of exercises available to any user of the present invention, and users can perform exercises that use the upper and lower extremity muscle groups simultaneously.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for suggesting goods for purchasing, the method comprising:
selecting, using a first electronic device, a first user;
selecting, using the first electronic device, one or more goods from one or more catalogs of goods;
constructing, using a processor, a message, wherein the message includes:
at least one of the one or more goods selected by a second user using the first electronic device;
a description of each of the goods included in the message; and
an interface with which the first user can select any of the goods included in the message;
sending, using a processor, the message to the first user on a second electronic device;
receiving, by the processor, any goods selected by the first user; and
sending, using the processor, a listing of any goods selected by the first user on the second electronic device.

2. The method as recited in claim 1, wherein the selecting the first user further comprises inputting, using the first electronic device, contact information of the first user.

3. The method as recited in claim 1, wherein the selecting the first user further comprises selecting the user from a list of users.

4. The method as recited in claim 1, wherein the message does not identify the identity of the second user.

5. The method as recited in claim 1, wherein the message is sent using a method selected from the group consisting of e-mail; text messaging; and social media.

6. The method as recited in claim 1, wherein the message further includes one or more goods generated by the processor, wherein the one or more goods generated by the processor share one or more characteristics with one or more of the goods selected from the one or more catalogs of goods.

7. The method as recited in claim 6, wherein the characteristics are selected from the group consisting of category of goods; relative price; brand of goods; color; utility; size; and style.

8. The method as recited in claim 1, wherein the goods selected by the first user further includes one or more goods selected by the first user that were not in the message sent to the first user.

9. The method as recited in claim 1, wherein one or more of:
the at least one of the one or more goods selected by the second user using the first electronic device;
the description of each of the goods contained in the message; and
the interface with which the first user can select any of the goods include in the message are accessible in the message through a link to a webpage.

10. The method as recited in claim 1, wherein the message further includes a prompt for the first user to select which goods included in the message the first user likes.

11. The method as recited in claim 10, wherein the message further includes a time limit in which the first user can respond to the prompt.

12. The method as recited in claim 1, further comprising storing payment information for the second user.

13. The method as recited in claim 12, further comprising automatically purchasing, using the processor, one or more goods selected by the first user.

14. A method for suggesting goods for purchasing, the method comprising:
selecting, using a first electronic device, two or more first users;
selecting, using one or more first electronic devices, one or more goods from one or more catalogs of goods;
constructing, using a processor, a message, wherein the message includes:
at least one of the one or more goods selected by at least one second user using the one or more first electronic devices;
a description of each of the goods included in the message; and
an interface with which each of the at least two first users can select any of the goods included in the message;
sending, using a processor, the message to the two or more first users on one or more second electronic devices;
receiving, by the processor, any goods selected by the two or more first users; and
sending, using the processor, a listing of any goods selected by the first user on the one or more second electronic devices.

15. The method as recited in claim 14, wherein the message is sent using a method selected from the group consisting of e-mail; text messaging; and social media.

16. The method as recited in claim 14, wherein the message further includes one or more goods generated by the processor, wherein the one or more goods generated by the processor share one or more characteristics with one or more of the goods selected from the one or more catalogs of goods.

17. The method as recited in claim 16, wherein the characteristics are selected from the group consisting of category of goods; relative price; brand of goods; color; utility; size; and style.

18. The method as recited in claim 14, wherein one or more of:
at least one of the one or more goods selected by at least one second user using the one or more first electronic devices;
a description of each of the goods included in the message; and
an interface with which each of the at least two first users can select any of the goods included in the message;
are accessible in the message through a link to a webpage.

19. The method as recited in claim 14, wherein the message further includes a prompt for each or the two or more first users to select which goods included in the message each of the two or more first users likes.

20. The method as recited in claim 19, wherein the message further includes a time limit in which each of the two or more first users can respond to the prompt.
